(19) United States
(12) Patent Application Publication
(10) Pub. No.: US 2009/0032367 A1
(43) Pub. Date: Feb. 5, 2009

(54) Vending Machine to Dispense Cans

(76) Inventor: Guy Anthome, Beverly Hills, CA (US)

Correspondence Address: WILSON DANIEL SWAYZE, JR., 3804 CLEARWATER CT., PLANO, TX, 75025, US

(21) Appl. No.: 11/833,381

(22) Filed: Aug. 3, 2007

(51) Int. Cl. G07F 7/08

(52) U.S. Cl. 194/210; 235/381

(57) ABSTRACT

A vending machine for dispensing a can includes a tray for holdings the can, a card device to accept a transaction card for payment of the can. The can includes a shirt.

### FIELD OF THE INVENTION

The present invention relates to an automatic article dispenser having multiple trays which dispenses cans including a T-shirt and receipt.

### BACKGROUND OF THE INVENTION

There are available, for different applications, automatic item, article or goods dispensers which store a large number of items in an ordered manner so that they may be supplied one at a time to a retrieval point on the introduction of a predetermined sum of money or a token into an automatic vending machine.

Various mechanisms have been designed for this purpose; such mechanisms for example exploit gravity or forced feed of vertically stacked objects. This allows for very compact machines. There also exist dispensers based on screw conveyors or having mobile compartments mounted on a wheel; these, however, are very bulky and take up considerable space, particularly in depth, relative to the number of items to be stored. This renders them quite unsuitable in situations where there are restrictions on space and, furthermore, they have the disadvantage of being of fixed size and devoid of the flexibility which would permit them to adapt to different dimensions of the stored items and thus maximize capacity.

French Pat. No. FR-A-710,935 describes a dispenser having a shaft on which a plurality of supporting elements are inserted, starting from its upper part, such supporting elements being spaced from each other by the thickness of their hub and carrying the items to be dispensed. The shaft has a screw portion which engages in an internal thread of the hubs, to support and space apart the supporting elements in the retrieval area.

This structure allows storage of the items to be dispensed in a small volume but is of complex construction, requires supporting elements having a particularly designed hub, which is difficult to manufacture, and has problems of reliability with respect to the engagement of a supporting element with the threaded part of the shaft; the maximum height of the items to be stored is moreover limited by the thickness of the hub, which is constant for all the supporting elements and cannot be adapted to items having different heights.

U.S. Pat. No. 4,671,426 discloses an automatic dispenser in which a vertically elongated housing has a screw at a rear end thereof whose lower portion is free from a screwthread. Fork-shaped rear edges of trays carrying articles to be dispensed are lowered by rotation of the motor-driven screw until they reach the thread-free portion whereupon the tray is dropped to the bottom of the housing at which an access opening is provided and to allow articles on the trays to be removed while the trays accumulate at the bottom of the housing.

### OBJECT OF THE INVENTION

It is therefore the object of this invention to provide an automatic dispenser of reduced volume, in particular of reduced depth, which can contain a large quantity of items, adapted to the bulk of the items themselves without imposing limits on their dimensions or fragility and without damaging them.

### SUMMARY OF THE INVENTION

The present invention is a turnkey, cashless and paperless merchandising solution in which a vending machine is used to display merchandising products which have been prepackage in metal cans as if they were collectible items. The vending machine and metal cans are manufactured with a vintage look. Graphics and finishing of the vending machine and metal cans exploit the symbols and details of the past to add to the authenticity of the product. To achieve the visual attraction, there is a coordination of style and symbols between the vending machine, the packaging and the content. These are all blended together in appealing illustration of the brand, creating a impulse buying situation for the consumer.

The vending machine of the present invention is characterized by a vintage marketing theme. The products are high quality specialty manufactured as articles which includes T-shirts as a proof of marketing concept. The packaging includes customized lightweight aluminum cans with specialized tops for the opening and is branded by the customers logo.

The vending machine requires purchase by debit/credit cards or gift cards only. The present invention is not a coin based spending solution. The consumer interface should ensure that the consumer always gets the items requested through inventory management and consumer product selection. The vending machine of the present invention uses a card which is a financial transaction such as a transaction card including a debit/credit gift card for the vending purchase.

Compensation for all the stakeholders in the sales cycle are completed at the time that the transaction is complete. Furthermore, a charitable contribution is made at the time of the purchase and a reward or incentive may be given to the customer.

The present invention accepts multiple payments methods including credit and debit but not coin or cash transactions. The vending machine of the present invention is fully automated to reduce operational costs. The vending machine of the present invention will provide for inventory management. The vending machine of the present invention will provide a unique consumer interface and purchasing experience. The vending machine of the present invention will provide for the simultaneous distribution of settlements to all the stakeholders by paying directly to suppliers, retailers and a third party involved in the transaction such as a charity or nonprofit organization. The vending machine of the present invention will provide for direct distribution of charitable contributions and provide inventory control and management with specialized and preprogrammed IC chips. The vending machine of the present invention will create a paperless solution for vending transaction between wholesalers and retailers. The present invention includes a receipt that is included in the can so that a printer is not required. The present invention facilitates a direct path between the consumer and manufacturer while allowing for future system upgrades via primary software upgrades.

Some advantages of the present invention include brand vertical vending and visual marketing with product and packaging for the branded marketing. The present invention provides a cashless, multiple payment options including contact-less payments, distribution settlement system and simultaneous payment to all shareholders. The present invention is paperless with the receipt in the can. The automated central control system administrators reduces operational cost including inventory controls. The present invention provides for automatic giving in terms of philanthrpic assistance.

Additionally, an automatic item dispenser which comprises an enclosure containing a vertically aligned screw shaft, on the thread of which rests the shaped edge of a plurality of trays, which carry the cans with the T-shirt and receipt inside to be dispensed, a drive motor connected to the shaft, to cause the screw to rotate providing a vertical displacement of the trays from a storage or accumulation point of the filled trays to a supply or retrieval point (access opening). Corresponding to this retrieval point, the enclosure which contains the screw shaft and trays has an opening, possibly fitted with some sort of door or cover, for access to the dispensed items. The apparatus is fitted with a card device for the activation of the drive motor on payment of the predetermined sum and with sensors which detect the position of the trays and thus control the rotation of the screw and enable the opening of the access door or cover in relation to the position of the trays.

The dispenser enclosure is fitted with a key or similarly operated aperture which allows the dispensed items to be replaced while the apparatus is disabled or in operation.

More particularly, the dispenser has a vertically aligned screw shaft which is free to rotate, located in the rear section of a rectangular shaped enclosure and driven by a motor.

The items to be dispensed are supported by metal trays which have fork-shaped rear edges inserted on the screw shaft, supporting them in a horizontal position; the rotation of the screw causes the trays to shift downwards, the rotation of the trays being prevented by the wall panels of the enclosure. The lower section of the enclosure constitutes a retrieval area fitted with an access aperture, the thread on the screw shaft terminates opposite this retrieval area at the bottom of the housing at which a storage area for the empty trays is provided.

Conveniently, a plurality of similar dispensers can be placed side by side, thus forming a multiunit dispensing apparatus for example for different sizes of shirts in the cans. In order to prevent vandalism and damage to the dispensing apparatus, a blocking apparatus can be connected to the enclosure of the dispenser to engage the trays and to prevent the unallowed removal of the trays.

The implementation of a dispenser according to the invention allows for a minimal space requirement which is slightly greater than the base dimensions of the largest item to be dispensed; the number of items contained and their height determine the vertical dimensions of the dispenser which usually does not suffer severe restrictions, admitting the possible extension to more than one floor and with one end of the apparatus suitable for reloading. This reloading operation may also occur during operation of the dispenser.

### BRIEF DESCRIPTION OF THE DRAWING

The above and other objects, features and advantages of the present invention will become more readily apparent from the following description, reference being made to the accompanying drawing in which:

FIG. 1 is a longitudinal cross-section taken along the line I-I of FIG. 2; and

FIG. 2 is a section along the line II-II of FIG. 1;

FIG. 3 illustrates a perspective view of the vending machine of the present invention;

FIG. 4 illustrates a shirt packed in the can;

FIG. 5 illustrates the can;

FIG. 6 illustrates a diagram of the vending machine of the present invention;

FIG. 7 illustrates a diagram of the vending host system gateway of the present invention;

FIG. 8 illustrates a diagram of the payment authorization and settlement gateway of the present invention;

FIG. 9 illustrates a system architecture of the present invention.

### DESCRIPTION

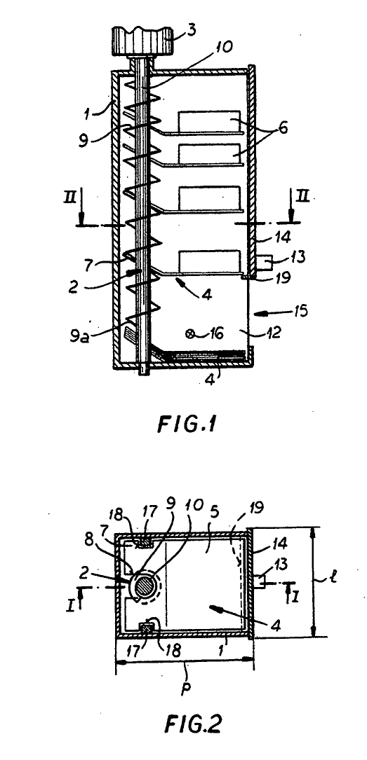

FIG. 1 shows a system including, in cross section, an automatic dispenser according to the invention, which consists of an enclosure 1, within which is a screw shaft 2 driven by a motor 3. On the screw shaft 2 are inserted a number of trays 4, each of which has a flat portion 5 on which are carried the items 6 including a can 502 holding a T-shirt 402 and receipt 504 for automatic vending, and an angled portion 7 with slot 8 shaped as a fork so as to fit onto screw shaft 2, as illustrated in FIG. 2. In this manner the screw thread 9 maintains the flat portion 5 of tray 4 in a horizontal position while the main body of the shaft itself guides the movement of the trays.

The counter-clockwise rotation of screw shaft 2, with right hand thread as shown, is produced by motor 3 and activated by a card device 302 such as the debit or credit card which is not illustrated. The rotation causes a downward displacement of the trays 4, their rotation being prevented by the side wall panels of the enclosure 1, until the lowermost tray frees itself from the extremity 9a of the thread 9 and slides down along the thread-free end of the screw shaft 10 to the bottom of a retrieval area 12 within enclosure 1, while a sensor 13 of electromechanical, optical, magnetic or similar type, having detected the passage of a tray 4, causes the motor 3 to be deactivated after a sufficient number of shaft rotations has assured that the tray 4, has in fact, dropped off the thread 9 of the screw 2.

The front wall 14 has an access opening or aperture 15 corresponding to the area 12 so that the purchased item 6 which is a can 502 including a T-shirt 402 and receipt 504 may be removed while the empty trays 4 accumulate at the bottom of area 12.

A sensor 16, for example of the optical type, may be present in the area 12 to prevent further activation of the dispenser until the requested item 6 has been removed from the area 12, thus freeing this area for the next tray 4 and its respective carried item including the can 502 with the T-shirt 402 and receipt 504 inside, thereby preventing jamming caused by improper use. When all the items 6 or cans 502 have been removed and all the trays 4 have accumulated at the bottom of the area 12, an operator may open the front wall panel 14, remove the trays 4 from said area 12 to insert them once more on the screw shaft 2 and restock the items 6 including the cans 502 with shirt 402 and receipt 504. To prevent unauthorized removal of trays 4 along with the items 6, the area 12 may be fitted with the blocking apparatus for the trays which may be disabled on opening the dispenser for restocking or, in general, can prevent the removing of the trays if the dispenser has not been opened. An example for such means is the projecting elements 17, protruding from the walls of the enclosure 1, which engages in the recess 18 of the trays.

As may be seen from FIG. 2, the dispenser presents the minimum of bulk, its width “1” being practically equal to the width of tray 4 plus the thicknesses of the wall panels of enclosure 1, while its depth “p” is equal to the useful depth of tray 4 plus the diameter of screw shaft 2 plus the thicknesses of the front and rear wall panels 14. It is thus possible to install a number of such dispensers side by side with base area dimensions practically equal to or slightly larger than the dimensions of the items stored, while the height and maximum number of items, corresponding to maximum storage capacity of each dispenser, determine the overall height.

The screw shaft 2 can be composed by a cylindrical central bar, or shaft 10, supported at its extremities and driven at one end by a motor. The thread may be composed of a length of metal of rectangular or circular cross-section helicoidally wound onto the central bar with the required pitch, fixed to the central bar by means of, for example, welded joints at its extremities and driven at one end by a motor. The thread may be composed of a length of metal of rectangular or circular cross-section helicoidally wound onto the central bar with the required pitch, fixed to the central bar by means of, for example, welded joints at its extremities; of course it is possible to obtain more precisely manufactured screws by machining, thus satisfying specific thread profile requirements.

As may be seen in the drawings, the vertical distance between successive trays or containers may be freely chosen and can be different for each stored item, for instance in case of dispensing of irregularly shaped or irregularly packed items, in order to allow an easy loading, without compulsory dimensions and at the same time allowing the maximum exploitation of available space.

The front edge of the lowermost of the trays carrying an object 6 rests against a small tooth 19, and the tray cannot be deflected downwardly, so causing the theft to be near impossible. When the screw 2 is operated, the portion 7 of the tray is lowered, tilting the tray 5 rearwardly, as far as the tray slips away from the small tooth 19; the tray can consequently return to a horizontal position and drop to the bottom of the retrieval area 12, in order to allow the object to be taken off.

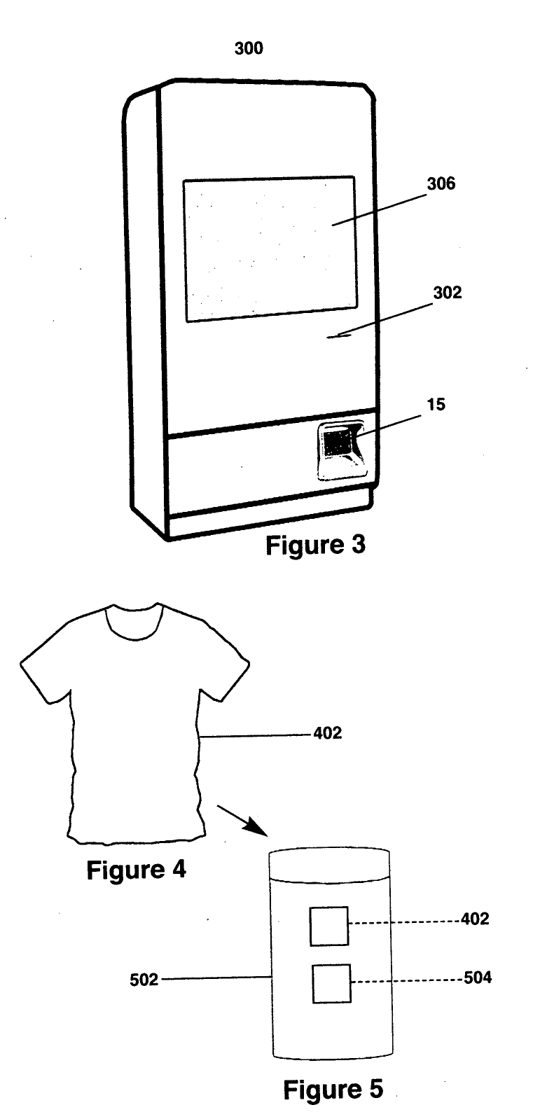

FIG. 3 illustrates a perspective view of the vending machine 300 of the present invention. FIG. 4 illustrates a shirt 402 which has been packed inside the can 502 along with a receipt as illustrated in FIG. 5.

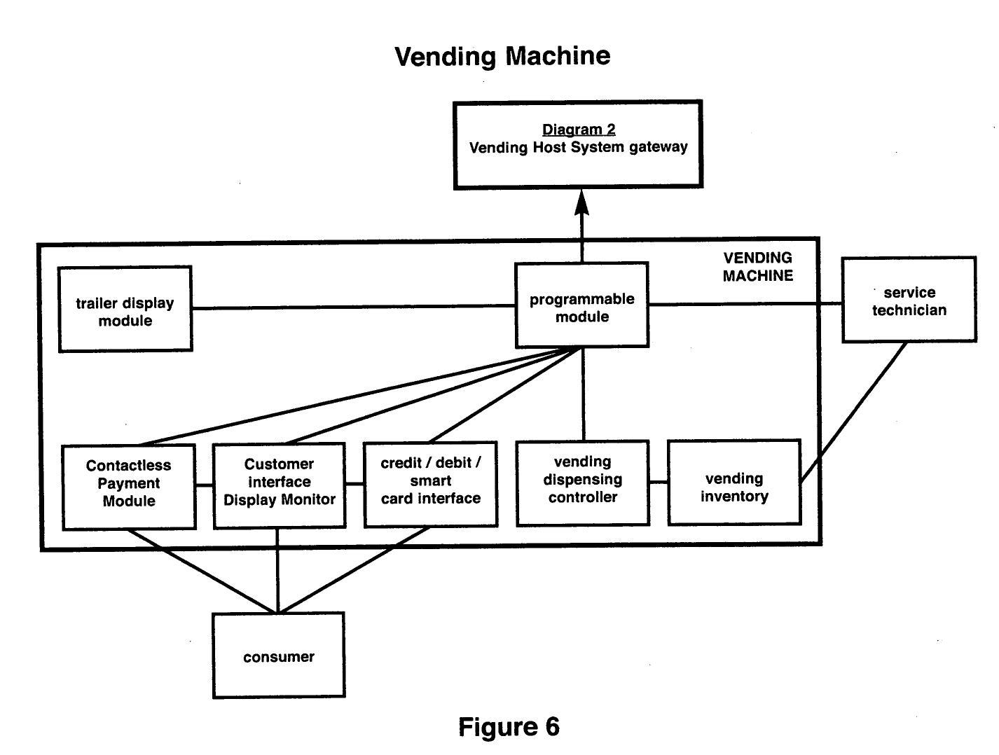

FIG. 6 illustrates a trailer display module 602, a contactless payment module 604, a consumer interface display/monitor 606, a credit/debit/smartcard interface 608, a vending dispensing controller 610, a vending inventory 612, a service technician 614 and a programmable module 616.

The credit card/debit payment interface 608 provides online authorization for credit card and debit card transactions. The interface 608 will cooperate with the US Payment Industry rules and regulations such that authorized transactions under the amount of $25 provide merchant protection against certain chargeback categories even though there is no signed payment slip or pin entered. The credit card/debit payment interface 608 includes fraudulent purchase protection and is connected to the Internet and can decline transactions if the same card has been used to buy more than a predetermined number of items, for example 3, on any vending machine across the system. Furthermore, if the same card is used on more than that one machine across a network in a simultaneous manner, indicating a skimmed card, all the transactions will be declined and the items will not be vended. The credit card/debit payment interface 608 will support the end of this settlement.

The credit/debit contactless card interface 604 may be a certified POS sale terminal with debit capability. A POS PIN pad can be provided if required by the machine operator. However, credit and debit card transactions under $25 if online authorized to not require a PIN to be entered or to have a signature to be provided in order to provide chargeback protection and merchant guarantee of payment.

The programmable module 616 allows the system program software to be upgraded remotely by use of a high-speed Internet connection.

The consumer interface display monitor 606 will show the items stocked within the vending machine and/or used to send messages to consumers. The consumer interface display monitor 606 includes a touch sensitive screen to simplify the selection of the items and to select the mode of payment.

The vending dispense controller 610 includes interface to the mechanical components in the system for dispensing a product. The vending dispense controller aides in ensuring the quality of the consumer experience by avoiding a stocking mistake made by the person maintaining the machine or replacing the inventory. The item desired by the customer may not be available within the machine because the inventory was improperly managed. The present invention employs contactless readers and chips to provide for accurate management of the inventory. These contactless chips include encoding to provide for unique identification of the product including the manufacturer, the design, the size, the sex (male or female) and color of the item. These contactless chips will allow the vending machine to identify each item as they are being loaded into the machine to determine if the item is correct and to determine if the item is placed at the correct location within the machine. If an incorrect item is detected or a correct item is placed at an incorrect location, an audible alarm is sounded and the system administrator 700 is notified. As each item is dispensed, the contactless read mechanism will detect which item has been sold and report this to the vending inventory module 612. Since the vending inventory module 612 knows the current inventory, once the inventory reaches a predetermined threshold level, the system administrator 700 will be advised of the inventory level.

Since the inventory is closely managed, the inventory of the vending machine can be continuously adjusted in order to avoid the disappointment of the consumer and provide a favorable experience for the consumer. The vending machine can be continually reprogrammed to allow for a larger stock of the most popular dispense items. Since the vending inventory 612 includes the position of each item in terms of rows and columns, the customer can make a selection from the touched sensitive screen and can advise the customer if an item is not available. The vending inventory 612 can offer alternatives to the customer if the first choice of the customer is not available. The alternatives can be offered in terms of size, design, color, and gender. Alternatively, if the first choice of the customer is not available, the vending machine can accept payment and allow the customer to reserve the first choice when it is restocked and made available for the customer.

The service technician 614 receives work orders from the system and providing status of these work orders back to the system. These work orders will include inventory restocking as well as mechanical problems identified with the vending machine. Before the service technician 614 replenishes his inventory, the service technician 614 receives a list of work orders from the warehouse including the inventory that will allow the service technician 614 to replenish the inventory by using the contactless chips and reader mechanism, to replenish stock and paper if the printer is included in the machine inventory and to perform other services. When the service technician 614 has completed the work order, a report is generated and sent to the system administrator 700 to reflect the inventory of the machine. The system administrator 700 will reconcile and balance inventory with the inventory manager, marketing, finance and administration and reset the alarm and help desk.

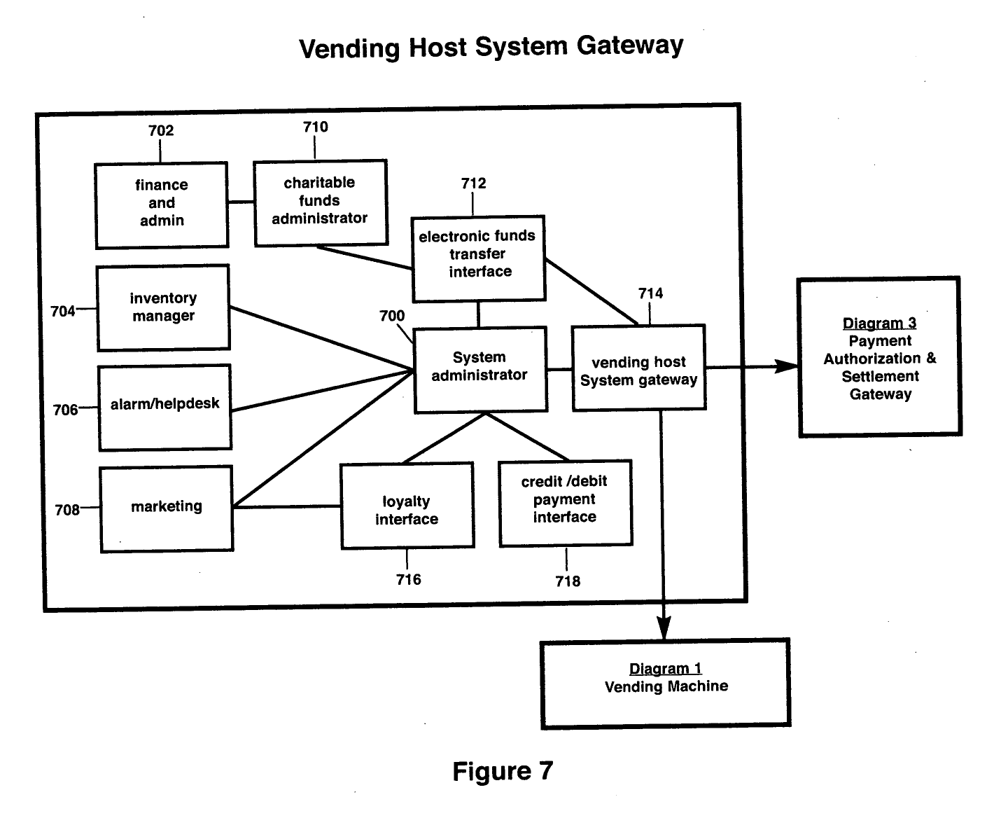

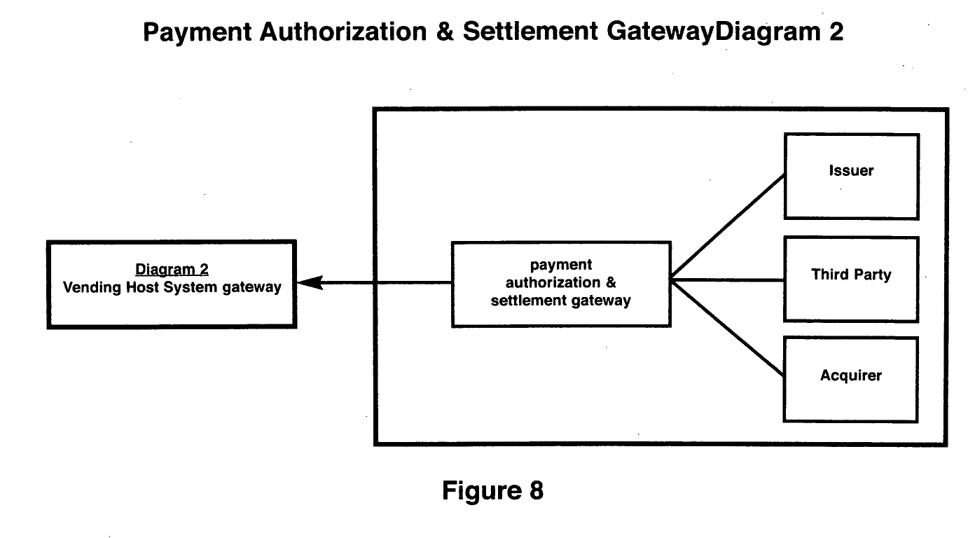

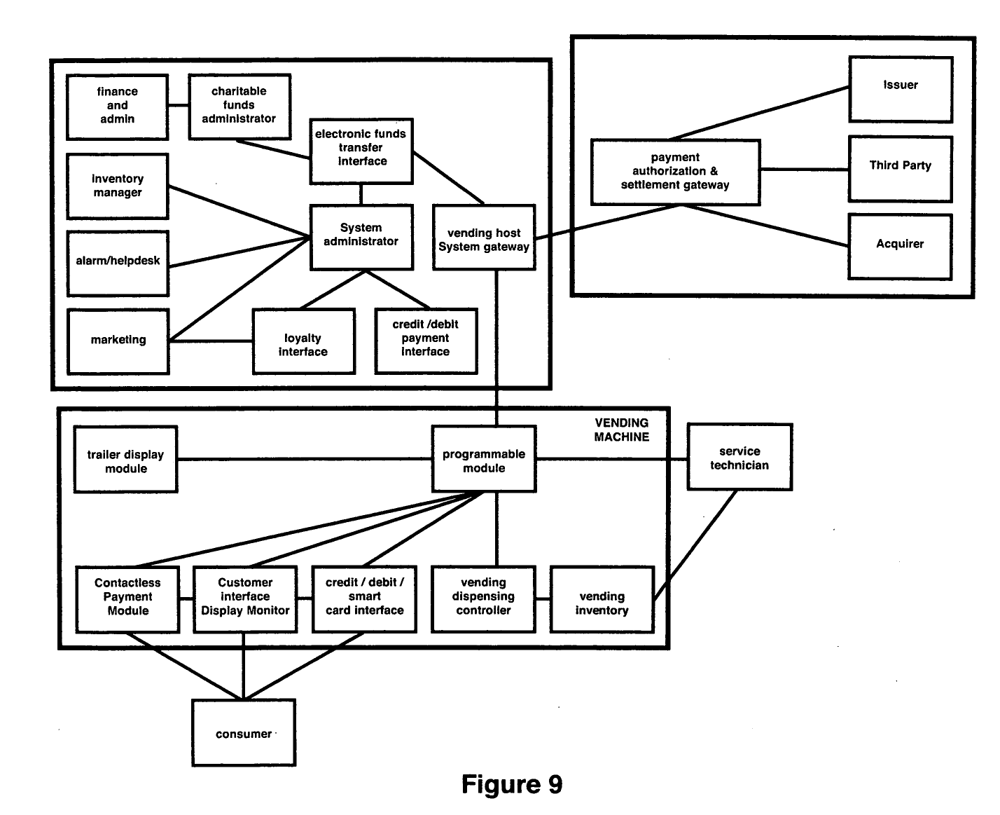

The vending host system gateway is illustrated in FIG. 7. The vending host system gateway 714 acts as a high-speed router between different components in the system and supports the needs of the system administrator 700. The components of the vending host system gateway includes finance and administration 702, an inventory manager 704, and alarm helpdesk 706, marketing 708, charitable funds administrator 710, electronic funds transfer interface 712, vending host system gateway 714.

The system administrator 700 performs system management functions including the management of backup of daily information, user accounts, distribution and settlement to stakeholders, charitable cause distributions, inventory management (The system administrator will over time, know by the month, the week, and the day, the vending statistics and will be able to adjust and manage the inventory accordingly.), electronic funds transfer, credit/debit payment and settlement, marketing and loyalty. The system administrator 700 will over time, know by month, week, and they the vending statistics and will be able to adjust and manage the inventory accordingly.

Finance administration 702 performs reconciliation of accounts between all stakeholders electronically for example over the Internet protocols or in terms of financial settlement by existing networks such as ACH or Swift transactions to accommodate direct deposits to the shareholders and beneficiaries that are related in nature. The functions of the finance and administration 702 will include management of merchants billing parameters, management merchant access to web site portals, the review of payments received and inventory sold by vending location, the review of current inventory, the review of electronic fund transfer activity, the distribution of funds for multi-level parties and multiparty, the reconciliation of distributions and the reporting of assets, the electronic settlement through automated clearinghouses (ACH) or by the preset requirements and other duties required by the client interface.

The inventory manager 704 will manage the inventory of all products offered within the system including the warehouse inventory, the in transit inventory, and the vending machine inventory. The management of vending machines includes for example where the vending machines are located, what type of product is being sold, maintaining the read-only view of marketing program etc., the management of service technician parameters for example which vending machines the service technicians are responsible for, assigning work orders for service technicians for example when to deliver which product for which vending machine and for which vending slot and reviewing inventory trends for example which inventory is stale or which inventory is selling too slow.

The inventory management 704 includes merchant location and contact information, vending machine serial numbers, how many products and which types of products can be placed in a particular vending machine, as TCP/IP address, the electronic report reporting and resetting of system controls. The inventory management 704 can enter dynamic information which includes selecting a marketing campaign from a predefined list as entered by the marketing company, selecting a particular vending machine to update the service schedule, selecting trailer and inventory from the marketing department and selecting the time to deploy. The inventory management 704 will select the skin, trailer inventory to stock, time to deploy and assigning a service job to a service technician.

The inventory management 704 will determine which inventory to remove from the vending machines and which inventory to replenish in the vending machines. The inventory management 704 will generate a work order for the service technician.

The electronic funds transfer interface 712 allows funds to be transferred automatically to/from the merchant and the vending operator.

A gift card interface can interface with a third-party system to allow for gift card payment and replenishment.

The loyalty interface 716 can interface with a third-party system for loyalty payment and replenishment.

The vending machine includes a processor 620 to manage the vending machine and may be a PC type processor with a full operating system such as Intel PC, running windows XP. The unit controls most elements of the vending machine and elements of the system administration functions. The processor should be able to store and play trailers or show the items to be dispensed while managing the vending machine logic and systems administration interface.

The system will provide real-time statistics were set system activity. Because of the capability to upgrade the system dynamically, the reporting capabilities will be customizable and upgradeable to meet to specifics of the location and a client. The real-time reports that can be generated in the least include by contactless code classified by gender, size (small, medium, large and X-large), items designed and item color, inventory by location, sales by location for example by location, item type, size and color, sales by marketing campaign which can be broken down by trailer, mechanical design, incentives, charitable contribution associated to location.

The vending machine of the present invention should accept multiple payment methods including credit, debit and loyalty redemption. The control of the vending machine should be centrally located and be fully automated to reduce operational costs. The vending machine of the present invention will provide a new customer interface and purchasing experience. The present invention provides for the simultaneous distribution of settlement to stakeholders and pays directly to suppliers retailers and any third party involved in the transaction, for example charity and nonprofit organizations. The present invention will provide for the direct distribution of charitable contributions and provide inventory control and management with specialized and preprogrammed IC chips. The present invention creates a paperless solution for pending transactions between wholesalers and retailers to establish a more direct path is established between consumers and manufacturers. The present invention allows for future system upgrades such as primarily software upgrades. The present invention has redesigned the entire sales cycle including three stages. The first stage is the presale stage involving the design of the product, the second is the consumer purchasing and payment experience and the third stage is the post sale payment and reconciliation among all the stakeholders including charitable contributions. The present invention amplifies printed advertising and multiplies through the payment process the vending machine market. The vending machine of the present invention makes the products more accessible, appealing and affordable then has been currently known. With the present invention, graphics and style coordination visually link the product packaging and vending machine portal displays in order to open new areas into vending creativity. By reducing the amount of time for all parties in the transaction to be paid, a new business model is created not only for the vending machine but for any transaction purchase at the point-of-sale device. The present invention provides an originating payment transaction to achieve a distributed payment solution for the entire product and manufacturing supply chain. This results in cost savings for the entire industry which are considerable and reduces the time for all parties to be paid. This creates a business model for the vending machine and eventually for any transaction purchase at a point-of-sale device. After the consumer initiates the debit/credit card transaction, the present invention accepts the financial transaction and simultaneously performs specific multiple payment operations. The present invention provides real-time payment processing on the vending machine which releases the product to the buyer and dispenses the funds in a predetermined manner to all the significant parties involved in the sales transaction. The present invention includes a payment process with real-time inventory control, sales statistics and product shrinkage through monitoring, inventory and fraudulent purchases through monitoring unusual patterns of usage. The design of the relationship among all the stakeholders and the allocation of renumeration, customer rewards and charitable contributions are part of the back-ended solution. The present invention is a solution to facilitate payment across an entire merchandising market place. The present invention is suited to companies and individuals to place their attention on quality brand recognition. The sales and marketing of the product through autonomous vending machines in combination with the payment solution is compelling.

The present invention provides the following advantages. It is a compact solution allowing the displayed storage of over approximately 200 T-shirts on 6-7 ft.² of space. This results in a high sale per square foot solution which could reach approximately $500 per square foot which is based on six sales per day at low cost overhead. Another advantage is high marketing performance, the attraction of T-shirts packaged in metal containers being distributed at a vending machine and positioning the operating brand as a marketing innovator. The attractive packaging provides a brand with a stronger shelf identification and better visual impact. Together these elements all combine to create a cohesive vending experience that is paperless for management, cashless for the transaction and effortless for all the stakeholders particularly the consumer. The present invention includes the creative union and fusion of marketing and technology into a brand identity from the vending delivery system. This brand identity depends upon the thematic association in the mind of the public of traditional as nostalgic themes that the vending machine head during the ‘50s’ and can be more accurately defined as the retro or vintage period.

The vending transaction purchase includes a financial transaction card, and interaction of the card in a way that compensate all the shareholders at the time of purchase including the manufacture, retailer, licensees and any third party entitled to payment. The present invention may also include a charitable contribution to a qualified charities and will also offer to the consumer a loyalty reward.

The technology performance requirements for the vending machine include completely wrapping the vending machine with a marketing skin to support the brand image and marketing concept of the company, a computer to manage the vending machine having a touch sensitive PC monitor to allow for product feeling, product selection in advertising, ‘The consumer experience’. The vending machine of the present invention may be connected to the Internet to allow for machine management, inventory management and payment management. The present invention includes a vending machine that should be sufficiently stocked to ensure that the customers receive the items that they want at the time that they want it.

The present invention includes an inventory management and technology solution to manage the machine inventory. The machine inventory ensures that the inventory is managed so that the most popular vended item is allocated the most space within the vending machine. The system administrator 700 knows what items are sold by the time of day, day of the week, week of the month in which items are vended by the type, color, size, gender etc. The vending machines can be reconfigured centrally to ensure that the vending machines carry the right stock items to meet the consumer demands on that particular vending machine and to meet a particular sales pattern. New stock items can be easily distributed and the stock of the vending machine reconfigured to allow new items to be dispensed.

The present invention includes system administrator 700. The inventory management process of the present invention for vending allows the system administrator 700 to know the exact inventory of a particular machine by item, size, color and gender. This allows the system administrator 700 to create an inventory pick list for the system administrator 700, allows the system administrator 700 to suggest machine reconfiguration to maximize the sales of the machine, allows the system administrator 700 to ensure that the vending machines do not run out of the most popularly sold items with a confidence factor determined by the system administrator 700 and allows the system administrator 700 to include a route management software to produce an optimized maintenance route to ensure that the maintenance operator visits the largest number of machines in the day and travels the shortest distance. The route management software ensures that the maintenance operator has the correct stock to refill the vending machines. As a consequence, the maintenance operator does not waste time on machines that do not need to be refilled.

The present invention includes the packaging of the item to be dispensed.

The package will include a low-cost contactless chip which may be about the size of a pinhead. This chip will include details of the package item such as the type of clothing, the design of the item, the brand, the size, the color, the gender etc. The chip would be similar to the ones currently required with Wal-Mart and Tesco products to help manage inventory and ultimately aiding check out. Procter & Gamble has begun to a tagging some of their products with tiny computer chips in order to track inventory and gain insight into consumer preferences.

The features of the present invention will be presented. The present invention includes a stocking feature which provides a complete portal body-wrap to present the correct brand and marketing image. The vending machine of the present invention provides a large stock capability which may be in the range of 160-250 cans depending upon the size of the vending machine. The present invention includes a mechanism with a shelf that moves up to a row from which the item is handed and then drops to deposit the item into a vend pocket.

The present invention includes chip inventory control which includes contactless readers to detect the contactless chips being placed at the loading bay of every row of the vending machine. Furthermore, a contactless reader is placed in the vend pocket. This aspect provides the ability to check that every item that should be loaded into the vending machine is in fact loaded into the correct vend row. This allows the system administrator 700 to be sure that every item is correctly loaded so that the desired configuration is obtained. If an item is incorrectly placed, the vending machine will activate a audible alarm so that the maintenance operator can correct the error. Additionally, a message will be sent to the system administrator 700 so that they can contact the operator if necessary.

The present invention provides inventory management by a machine dispensing log found in the vending inventory 612. When an item is dispensed from the vending machine, an entry will be made into the machine dispense log which can be used to provide the basis for just-in-time inventory reports, reports on vending machine sales by time, day, week and type of item. This information can be used to provide a suggested configuration to the system administrator 700 to maximize sales and customer satisfaction.

The present invention includes a customer interface 606 which can be managed through a keypad such as the ones found on an ATM machine. When the consumer desires to buy an item from the vending machine, the customer will do so through the keypad.

The present invention includes vending inventory management 612. The largest vending machine can hold approximately 450 12 ounce cans or 360 20 ounce bottles. If the can to be dispensed is identified by row and column, then the vending correct item would be dependent upon a stocker of the vending machine placing the vending item at the correct row and column. The vending machine should display a menu of the contents of the vending machine for example by color, size, gender etc.

No printer is required.

The present invention can be connected to a high-speed Internet line so that the system administrator 700 may download videos of the items dispensed, so that the system administrator 700 can authorize transactions online and so that the system administrator 700 can manage machine sales configurations. If the vending machine is permanently connected to the Internet, then the sales configuration and maintenance can be centrally managed. The system administrator 700 could produce a report of which machines are to be restocked and to produce an inventory pick list. Furthermore, if the route management software is employed, the systems administrator can provide an optimized route to minimize travel and reduce maintenance overhead and staffing levels.

Connecting to vending machines to high-speed Internet line will tend to reduce the number of potential locations available for the connected vending machines and increase installation and running costs.

If the inventory includes a contactless chip in each can, the system administrator 700 will know what items have been sold by type, gender, size, color, design etc. The system administrator 700 will know the time of vending and know the frequency of selling by type. Consequently, stocking recommendations could be generated. If the vending machines include a monitor, then the monitor could include a touchscreen for the user to select the item type and the size. Stock could be managed to reflect a number of dissatisfied customers who are dissatisfied because of insufficient stock.

The advantages of using contactless chips assure that the items are placed in the correct location. Additionally, it is ensured that the machine was always stock with the correct item, stock was monitored and pilfering is controlled, the performance of the maintenance person can be monitored, and the customer always gets what they expect. Combining the contactless chips in the touchscreen monitor, the customer could touch the item in the size they wish to purchase.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A vending machine for dispensing a can, comprising:
a tray for holdings said can;
a card device to accept a transaction card for payment of said can;
wherein said can includes a shirt.

2. A vending machine for dispensing a can as in claim 1, wherein said vending machine includes an access aperture for dispensing the can.

3. A vending machine for dispensing a can as in claim 1, wherein said can includes a specialty top.

4. A vending machine for dispensing a can as in claim 3, wherein said can includes a brand logo.

5. A vending machine for dispensing a can as in claim 1, wherein said vending machine is characterized by a vintage marketing theme.

6. A vending machine for dispensing a can as in claim 1, wherein said transaction card is a debit card.

7. A vending machine for dispensing a can as in claim 1, wherein said transaction card as a credit card.

8. A vending machine for dispensing a can as in claim 1, wherein said transaction card is a gift card.

9. A vending machine for dispensing a can as in claim 1, wherein said can includes a receipt for the transaction.

10. A system for a vending machine for dispensing a can, comprising:
a tray for holdings said can;
a card device to accept a transaction card for payment of said can;
wherein said can includes a shirt.

11. A system for a vending machine for dispensing a can as in claim 10, wherein said vending machine includes an access aperture for dispensing the can.

12. A system for a vending machine for dispensing a can as in claim 10, wherein said can includes a specialty top.

13. A vending machine system; comprising:
a processor to control a vending machine of said vending machine system;
said vending machine being connected to an Internet for communication with said vending machine system;
a contactless card interface including a sale terminal adapted to accept a debit card, a credit card, a gift card and a loyalty card.

14. A vending machine system as in claim 13, wherein vending machine system includes a system administrator and wherein said vending machine is centrally controlled by said system administrator.

15. A vending machine system as in claim 14, wherein said vending machine system is adapted to be fully automated to reduce costs.

16. A vending machine system as in claim 13, wherein said vending machine system includes an inventory manager to provide inventory management of said vending machine.

17. A vending machine system as in claim 14, wherein said system administrator is adapted to provide distribution of settlement from the vending machine to stakeholders on a daily basis.

18. A vending machine system as in claim 13, wherein said vending machine system includes a charitable funds administrator to provide a direct distribution of charitable contributions.

19. A vending machine system as in claim 14, wherein said system administrator is adapted to receive future system upgrades through said Internet.

20. A vending machine system as in claim 14, wherein said system administrator is adapted to reconfigure stock of said vending machine.
